(19) United States
(12) Patent Application Publication
(10) Pub. No.: US 2012/0183348 A1
(43) Pub. Date: Jul. 19, 2012

(54) DRIVE UNIT WITH GASKET

(75) Inventor: Kurt Waizenegger, Aitrach (DE)

(73) Assignee: MULTIVAC SEPP HAGGENMUELLER GMBH & CO. KG, Wolfertschwenden (DE)

(21) Appl. No.: 13/332,618

(22) Filed: Dec. 21, 2011

(30) Foreign Application Priority Data
Dec. 22, 2010 (DE) 10 2010 055 674.2

(51) Int. Cl. F16J 15/06

(52) U.S. Cl. 403/288

(57) ABSTRACT

A drive unit according to the present disclosure comprises a motor housing and a transmission housing. The drive unit further comprises a gasket provided between the motor housing and the transmission housing.

### CROSS-REFERENCE TO RELATED APPLICATIONS

This application claims foreign priority benefits under 35 U.S.C. § 119(a)-(d) to German patent application number DE 102010055674.2, filed Dec. 22, 2010, which is incorporated by reference in its entirety.

### TECHNICAL FIELD

The disclosure relates to a drive unit comprising a motor housing and a transmission housing as well as a gasket.

### BACKGROUND

Drive units comprising a motor and a transmission are known. In the foodstuff industry, the cleanability of such drive units must meet particularly high requirements. The drive units are therefore varnished as a complete unit for such cases of use, so that they are able to resist the cleaning agents, some of which are particularly aggressive. The drive units are, for example, also used for driving delta robots, said delta robots being used, by way of example, for feeding products into plastic trays or troughs formed in films/foils. A continuous coat of varnish applied throughout the motor and transmission housings meets the requirements which are to be satisfied in the field of foodstuffs. If problems caused by a motor or a transmission should arise, it will be necessary to replace the drive unit as a whole. This is expensive, since the motor is normally a servomotor, and since the transmission may be implemented as a planetary gear. The replacement of a motor or of a transmission leads to a splitting of the varnished surface at the point of separation between the motor housing and the transmission housing. This point of separation continues to exist also after the replacement of a motor or a transmission, unless the remounted drive unit is varnished once more. This has the effect that, when the drive unit is being cleaned, the cleaning liquid may enter below the varnish at the point of separation and the additives to the cleaning liquid, part of which are very aggressive, may separate the varnish from the housing, whereby the varnish will be damaged. Such damage is not admissible in the sphere of foodstuffs.

### SUMMARY

It is an object of the present disclosure to provide a hygienic and cleanable drive unit, which comprises a motor housing and a transmission housing (or gear box) and which offers improved cleaning possibilities and allows replacement of a motor or of a transmission at a reasonable price.

A drive unit according to the present disclosure comprises a motor housing and a transmission housing (or gear box), said motor housing and/or said transmission housing being varnished separately from the respective other housing and said motor housing being connected to said transmission housing. A gasket is provided between the motor housing and the transmission housing, a first interface of the motor housing and a second interface of the transmission housing being partially in planar contact with one another in the axial direction of the drive unit and the gasket being compressed, said gasket being a silicone gasket. The silicone gasket is admissible in the field of foodstuffs and it is sufficiently resistant to cleaning liquids, which contain aggressive additives, so that the cleaning liquid will be prevented from coming into contact with an edge portion of the varnish so as to prevent an ingress of the cleaning liquid below the varnish. The partial planar contact between the first interface of the motor housing and the second interface of the transmission housing may establish a gap of a predetermined width for accommodating therein the gasket between the motor housing and the transmission housing.

Preferably, the gasket is implemented as a thin plate and has a thickness of 1.5 mm to 2.0 mm. In this form the silicone gasket can be produced at a reasonable price.

The outer contour of the gasket is preferably congruent with the outer contour of the interface of the motor housing or of the transmission housing. Thus, the varnish only has to extend up to and into an outer subarea of the interface, but it has to extend so far that no edge of the margin of the varnish is located outside of the gasket.

For the purpose of sealing, the gasket is preferably compressed by up to 0.5 mm, preferably only by up to 0.2 mm, so as to prevent cleaning liquids from entering between the gasket and the motor housing and/or the transmission housing.

Preferably, the coat of varnish of the motor housing and/or of the transmission housing is configured such that it extends up to and into the interface area which is covered by the gasket so as to prevent liquids from entering below the coat of varnish.

The drive unit preferably comprises screws for connecting the motor housing to the transmission housing and washers are provided between the screws and the transmission housing or the motor housing so as to prevent damage to the coat of varnish of the motor housing or the transmission housing during mounting.

In the following, an advantageous embodiment of the present disclosure will be explained in more detail with reference to the below drawings.

### BRIEF DESCRIPTION OF THE DRAWINGS

FIG. 1 is a schematic view of a delta robot with a drive unit according to the present disclosure;

FIG. 2 is a schematic view of the drive unit showing a transmission housing and a motor housing;

FIG. 3 is an enlarged view of detail F of FIG. 2; and

FIG. 4 is a vertical section through the area of the drive unit in which interfaces of the transmission housing and the motor housing are in contact with each other.

### DETAILED DESCRIPTION

Identical components are provided with identical reference numerals throughout the figures.

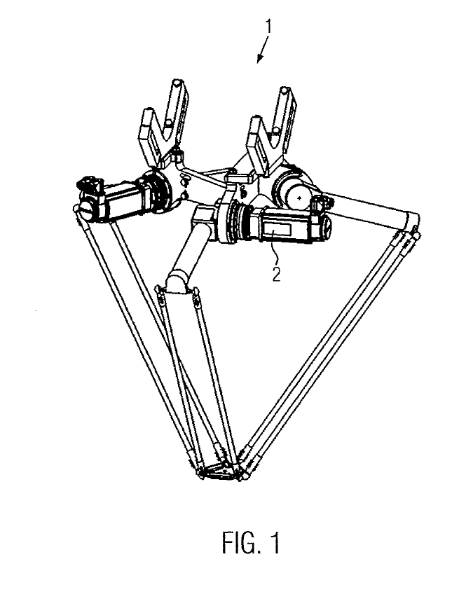

FIG. 1 shows a delta robot 1 with three drive units 2 according to the present disclosure, each of said drive units 2 driving a pivotal movement of an arm of the robot.

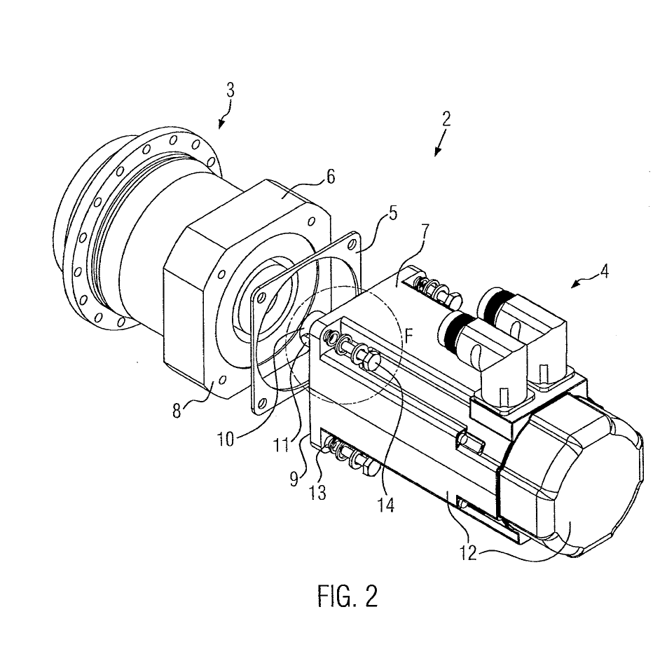

FIG. 2 shows a drive unit 2 with a transmission (or gear) 3 and a motor 4. A gasket 5 is mounted between a transmission housing 6 and a motor housing 7, said gasket 5 covering a first interface 8 of the transmission housing 6 and a second interface 9 of the motor housing 7 to a very large extent. Via a motor shaft 10 with a fitting key 11 the torque is transmitted to the transmission 3 by means of a shaft support, which is not shown. Alternatively, it is also imaginable to provide a clamping set in the transmission 3 by means of which the motor shaft 10 is axially centered without making use of the fitting key 11.

By way of example, the transmission housing 6 is made of anodized aluminum, or other material having anodized outer surfaces, and the motor housing 7 is coated or varnished with a coat of varnish, lacquer, or other protective coating on the outer surfaces 12 thereof up to and into the area of interface 9. If the transmission 3 or the motor 4 should fail, the faulty part 3, 4 can be demounted and the new part 3, 4 can be mounted without any necessity of varnishing the drive unit 2 as a whole, since the gasket 5 seals the edges at the end areas of the coat of varnish against cleaning liquids.

Washers 15 are provided so that, when the motor housing 7 is being mounted onto the transmission housing 6, the coat of varnish in the area of a mounting hole 13 will not be damaged by connecting members, such as screws 14, provided for interconnecting the two housings 6, 7, i.e. so as to prevent an ingress of cleaning liquids below the coat of varnish also at these points.

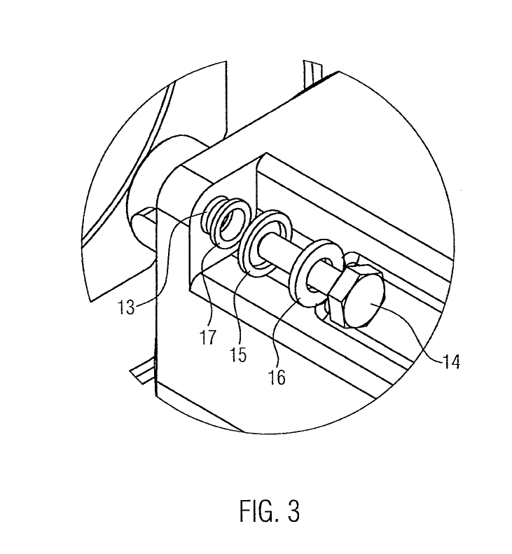

FIG. 3 shows an enlarged view of detail F of FIG. 2. When the motor housing 7 is being mounted onto the transmission housing 6, the screw 14 with a ring washer 16 acts on a collar bush 17 inserted in the mounting hole 13. The ring washer 16 is screw fastened into blocking engagement with the collar bush 17. The silicone washer 15 is in sealing contact with the collar bush 17 and it is sealingly disposed between the motor housing 7 and the ring washer 16. The thickness of the silicone washer 15 exceeds the height of the collar of the collar bush 17 by a differential dimension, and the silicone washer 15 is compressed by this differential dimension so as to achieve the sealing effect. The differential dimension is preferably smaller than 0.5 mm.

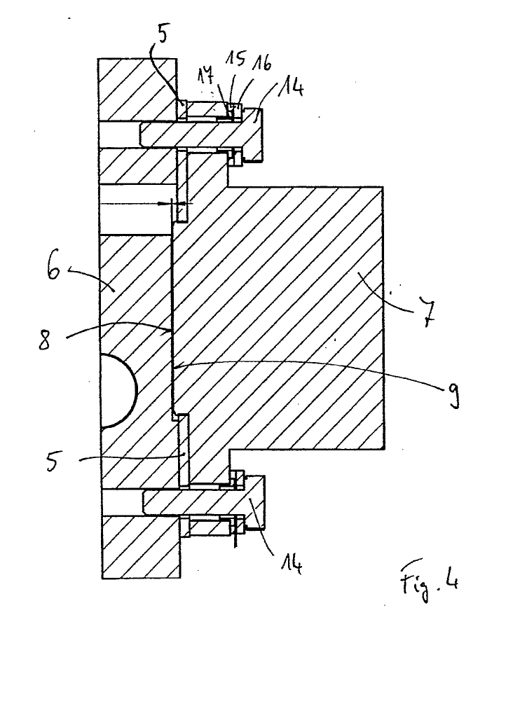

FIG. 4 shows a vertical section through the area of the drive unit 2 in which the interface 9 of the motor housing 7 and the interface 8 of the transmission housing 6 are partially in planar contact with each other. As visible in FIG. 4, the central portion of the interface 9 of the motor housing 7 has a projection which extends beyond the gasket 5. In the situation shown in FIG. 4, in which the transmission housing 6 and the motor housing 7 are coupled to each other, this projecting central portion of the interface 9 of the motor housing 7 is in planar abutment with the interface 8 of the transmission housing 6. The gasket 5 has an initial thickness such that it is compressed when planar contact is established between the two interfaces 8, 9.

FIG. 4 also shows the corresponding situation at the screw 14. In particular, it can be appreciated that the ring washer 16 is in partial planar contact with the collar of the collar bush 17, when the screw 14 is sufficiently tightened. Further, the silicone washer 15 has an initial thickness such that it is compressed when contact is established between the ring washer 16 and the collar bush 17 and the collar bush 17 itself abuts a lateral flange of the motor housing 7.

In another embodiment, the transmission housing 6 and the motor housing 7 may each be provided with a coat of varnish or other protective coating on their respective outer surfaces. Furthermore, for each of the transmission housing 6 and the motor housing 7, the protective coating may extend up to and into the area of the respective interface that is covered by the gasket 5 when the transmission housing 6 and the motor housing 7 are mounted together.

While exemplary embodiments are described above, it is not intended that these embodiments describe all possible forms of the invention. Rather, the words used in the specification are words of description rather than limitation, and it is understood that various changes may be made without departing from the spirit and scope of the invention. For example, the features of various implementing embodiments may be combined to form further embodiments of the invention. In addition, other embodiments may be practiced without one or more of the specific features explained in the above description.

What is claimed is:

1. A drive unit comprising;
a motor housing having a first interface;
a transmission housing connected to the motor housing and having a second interface; and
a silicone gasket provided between the motor housing and the transmission housing;
wherein the motor housing and/or the transmission housing are/is varnished separately from the respective other housing, and wherein the first interface and the second interface are partially in planar contact with one another in an axial direction and the gasket is compressed.

2. A drive unit according to claim 1 wherein the gasket is implemented as a thin plate.

3. A drive unit according to claim 2 wherein the gasket has a thickness of 1.5 mm to 2 mm.

4. A drive unit according to claim 1 wherein the gasket has an outer contour that is congruent with an outer contour of the first interface of the motor housing or of the second interface of the transmission housing.

5. A drive unit according to claim 1 wherein the gasket is compressed by up to 0.5 mm for the purpose of sealing.

6. A drive unit according to claim 1 wherein the gasket extends between the first and second interfaces, and the varnish of the motor housing and/or of the transmission housing is configured such that it extends up to and into an area of the respective interface that is covered by the gasket.

7. A drive unit according to claim 1 wherein the drive unit comprises a plurality of screws for connecting the motor housing to the transmission housing, and washers that are provided between the screws and the transmission housing or the motor housing so as to prevent damage to the varnish of the motor housing and/or of the transmission housing during mounting.

8. A drive unit according to claim 1 wherein one of the housings is varnished, and the other housing comprises an anodized outer surface.

9. A drive unit comprising;
a motor housing having a first interface;
a transmission housing connected to the motor housing and having a second interface; and
a silicone gasket provided between the motor housing and the transmission housing and being compressed by the housings in an axial direction;
wherein at least one of the housings is provided with a protective coating separately from the respective other housing, and wherein the first interface and the second interface are partially in contact with one another in the axial direction.

10. A drive unit according to claim 9 wherein the gasket is implemented as a thin plate.

11. A drive unit according to claim 10 wherein the gasket has a thickness of 1.5 mm to 2 mm.

12. A drive unit according to claim 9 wherein the gasket has an outer contour that is congruent with an outer contour of the first interface of the motor housing or of the second interface of the transmission housing.

13. A drive unit according to claim 9 wherein the gasket is compressed by up to 0.5 mm for the purpose of sealing the drive unit.

14. A drive unit according to claim 9 wherein the gasket extends between the first and second interfaces, and the protective coating of the at least one housing is configured such that the protective coating extends up to and into an area of the respective interface that is covered by the gasket.

15. A drive unit according to claim 9 wherein the drive unit comprises a plurality of fastening members for connecting the motor housing to the transmission housing, and washers that are provided between the fastening members and the transmission housing or the motor housing so as to prevent damage to the protective coating during mounting of the housings.

16. A drive unit according to claim 9 wherein one of the housings has the protective coating, and the other housing comprises an anodized outer surface.

17. A drive unit according to claim 9 wherein the protective coating comprises varnish.

18. A drive unite according to claim 9 wherein the gasket defines an opening, and one housing has a projection that partially defines the respective interface, and wherein the projection extends at least partially through the opening and contacts the interface of the other housing.
